(19) United States
(12) Patent Application Publication
(10) Pub. No.: US 2008/0101761 A1
(43) Pub. Date: May 1, 2008

(54) Weighted occlusion costing

(76) Inventor: Simon Widdowson, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/591,345

(22) Filed: Oct. 31, 2006

(51) Int. Cl. H04N 5/93

(52) U.S. Cl. 386/52

(57) ABSTRACT

In a method for determining a weighted occlusion cost for presenting an image within a non-uniform viewing region image, saliency data for an image to be displayed in a non-uniform viewing region is received. A layout orientation for presenting the image in the non-uniform viewing region is received. A weighted saliency map of the non-uniform viewing region is received. The image saliency data and said weighted saliency map are utilized to determine a weighted occlusion cost for the layout orientation.

### TECHNICAL FIELD

Embodiments of the present technology relate to positioning a digital image within a viewing region. More specifically, embodiments of the present technology relate to the use of weighted occlusion costing to assist in the layout of a digital image in a non-uniform viewing region.

### BACKGROUND

With the rapid rise in use of digital cameras and personal computers, the need to display digital images in an attractive manner is becoming increasingly prevalent. Slide shows are one way to display digital images and satisfy this need. Printed photographs are another way to display digital images. Each of these methods typically assumes that the viewable saliency in any portion of the viewing region such as, for example, on a screen or in a printed photograph, is uniform. That is, the quantity of visible saliency is important, while the arrangement of the saliency in the viewing region is irrelevant. In the majority of print and slideshow type applications, these are valid constraints that work well since it is apparent that saliency is either visible or invisible, with nothing in between.

However, these constraints do not hold true when visibly depicting a digital image in a non-uniform viewing region. This is because the shape or some other attribute of the non-uniform viewing region causes a non-uniform distribution of viewable salience. A common t-shirt provides one example of a non-uniform viewing region. For instance, if an image is printed around the circumference of the body of the t-shirt, the front and rear of the t-shirt will be very visible (high viewable saliency), while areas beneath sleeves or the arms of a wearer will be hard to see (low viewable saliency). Thus, in this example, the distribution of viewable salience around the circumference of the body of the t-shirt is not uniform as it would be in a typical printed photograph or projected image.

Currently, manual placement is the best method for laying out an image in a non-uniform viewing region. This can deliver a good result, but is tedious and time consuming. Current automated processes for laying out a digital image operate without regard to image saliency which is obstructed due to the non-uniform nature of the viewing region. Thus, automated processes generally deliver very poor results when utilized to layout images in non-uniform viewing regions.

The prevalence of digital images is increasing as are the nature and variety of the viewing regions in which these images are displayed. However, as described, existing methods for laying out images in non-uniform viewing regions are tedious and time consuming or deliver poor results.

### BRIEF DESCRIPTION OF THE DRAWINGS

The accompanying drawings, which are incorporated in and form a part of this specification, illustrate embodiments of the present technology for weighted occlusion costing and, together with the description, serve to explain principles discussed below:

FIG. 1 is a diagram of an example computer system used in accordance with embodiments of the present technology.

FIG. 2 is a block diagram of a weighted occlusion costing system, according to an embodiment.

FIG. 3 is a flow diagram of a method determining a weighted occlusion cost for presenting an image within a non-uniform viewing region, according to one embodiment.

FIG. 4 represents a digital image, which will be utilized to describe embodiments of the present technology.

FIG. 5 is an example of a saliency map of the digital image shown in FIG. 4.

FIG. 6 is a portable audio playing device, which will be utilized to describe embodiments of the present technology.

FIG. 7 is an example non-uniform viewing region in the form of a printable decal template for the portable audio playing device shown in FIG. 6.

FIG. 8 is an example layout saliency distribution map for a layout of the digital image of FIG. 4 within the printable decal template of FIG. 7.

FIG. 9 is an example weighted saliency map of the non-uniform viewing region represented by the printable decal template of FIG. 7, according to one embodiment.

FIG. 10 is an example mapping of the weighted saliency distribution for one layout of the digital image of FIG. 4 displayed within the printable decal template of FIG. 7, according to one embodiment.

FIG. 11 is a flow diagram of a method for determining a layout orientation for presenting an image with a non-uniform viewing region, according to one embodiment.

FIG. 12 an example of a layout orientation of the image of FIG. 4 within the printable decal template of FIG. 7, according to one embodiment.

FIG. 13 is an example of a printable decal applied to the portable audio player of FIG. 6, according to one embodiment.

The drawings referred to in this description should not be understood as being drawn to scale unless specifically noted.

### DETAILED DESCRIPTION

Reference will now be made in detail to embodiments of the present technology for weighted occlusion costing, examples of which are illustrated in the accompanying drawings. While the present technology is described in conjunction with various embodiments, it will be understood that they are not intended to limit the present technology to these embodiments. On the contrary, the presented technology is intended to cover alternatives, modifications and equivalents, which may be included within the spirit and scope the various embodiments as defined by the appended claims. Furthermore, in the following detailed description, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present technology.

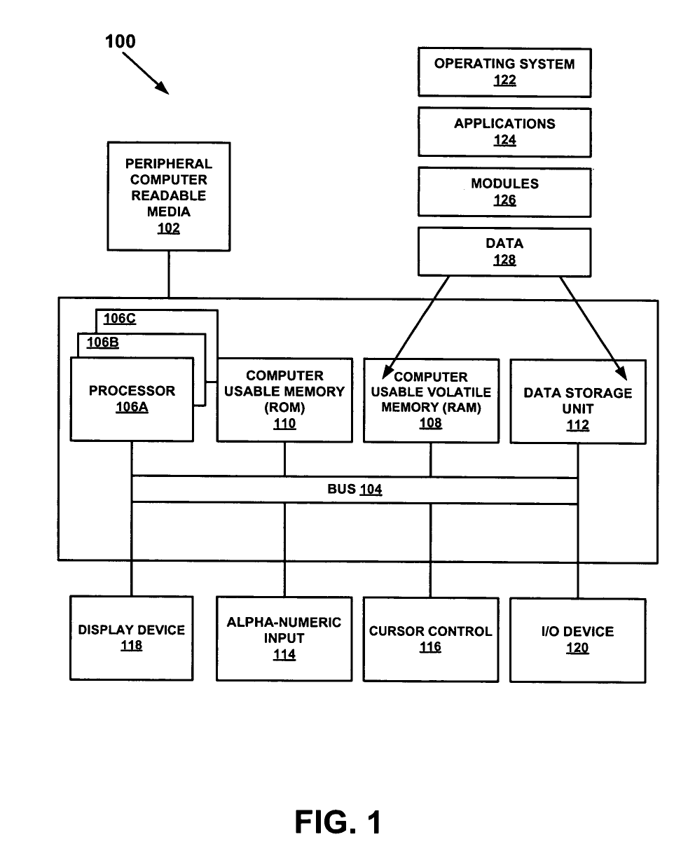

Unless specifically stated otherwise as apparent from the following discussions, it is appreciated that throughout the present detailed description, discussions utilizing terms such as “receiving”, “utilizing”, “determining”, “comparing”, or the like, refer to the actions and processes of a computer system (such as computer 100 of FIG. 1), or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology is also well suited to the use of other computer systems such as, for example, optical and virtual computers. Additionally, it should be understood that in embodiments of the present technology, one or more of the steps can be performed manually.

### Example Computer System Environment

With reference now to FIG. 1, portions of the present technology are composed of computer-readable and computer-executable instructions that reside, for example, in computer-usable media of a computer system. That is, FIG. 1 illustrates one example of a type of computer that can be used to implement embodiments, which are discussed below, of the present technology. FIG. 1 illustrates an example computer system 100 used in accordance with embodiments of the present technology. It is appreciated that system 100 of FIG. 1 is an example only, and that the present technology can operate on or within a number of different computer systems including general purpose networked computer systems, embedded computer systems, optical computer systems, virtual computer systems, server devices, client devices, various intermediate devices/nodes, stand alone computer systems, digital cameras, multimedia consoles, multimedia handheld devices, and the like. As shown in FIG. 1, computer system 100 of FIG. 1 is well adapted to having peripheral computer readable media 102 such as, for example, a floppy disk, a compact disc, and the like coupled thereto.

System 100 of FIG. 1 includes an address/data bus 104 for communicating information, and a processor 106A coupled to bus 104 for processing information and instructions. As depicted in FIG. 1, system 100 is also well suited to a multi-processor environment in which a plurality of processors 106A, 106B, and 106C are present. Conversely, system 100 is also well suited to having a single processor such as, for example, processor 106A. Processors 106A, 106B, and 106C may be any of various types of microprocessors. System 100 also includes data storage features such as a computer usable volatile memory 108, e.g. random access memory (RAM), coupled to bus 104 for storing information and instructions for processors 106A, 106B, and 106C. System 100 also includes computer usable non-volatile memory 110, e.g. read only memory (ROM), coupled to bus 104 for storing static information and instructions for processors 106A, 106B, and 106C. Also present in system 100 is a data storage unit 112 (e.g., a magnetic or optical disk and disk drive) coupled to bus 104 for storing information and instructions. System 100 also includes an optional alphanumeric input device 114 including alphanumeric and function keys coupled to bus 104 for communicating information and command selections to processor 106A or processors 106A, 106B, and 106C. System 100 also includes an optional cursor control device 116 coupled to bus 104 for communicating user input information and command selections to processor 106A or processors 106A, 106B, and 106C. System 100 of the present embodiment also includes an optional display device 118 coupled to bus 104 for displaying information.

Referring still to FIG. 1, optional display device 118 may be a liquid crystal device, cathode ray tube, plasma display device or other display device suitable for creating graphic images and/or symbols or alphanumeric characters recognizable to a user. Optional cursor control device 116 allows the computer user to dynamically signal the movement of a visible symbol (cursor) on a display screen of display device 118. Many implementations of cursor control device 116 are known in the art including a trackball, mouse, touch pad, joystick, directional and input keys on a multimedia remote control, or special keys on alpha-numeric input device 114 capable of signaling movement of a given direction or manner of displacement. Alternatively, it will be appreciated that a cursor can be directed and/or activated via input from alpha-numeric input device 114 using special keys and key sequence commands. System 100 is also well suited to having a cursor directed by other means such as, for example, voice commands.

System 100 also includes an I/O device 120 for coupling system 100 with external entities. For example, in one embodiment, I/O device 120 is a modem for enabling wired or wireless communications between system 100 and an external network such as, but not limited to, the Internet.

Referring still to FIG. 1, various other components are depicted for system 100. Specifically, when present, an operating system 122, applications 124, modules 126, and data 128 are shown as typically residing in one or some combination of computer usable volatile memory 108, e.g. random access memory (RAM), and data storage unit 112. In one embodiment, the present technology is stored, for example, as an application 124 or module 126 in memory locations within RAM 108 and/or memory areas within data storage unit 112.

### Weighted Occlusion Costing System

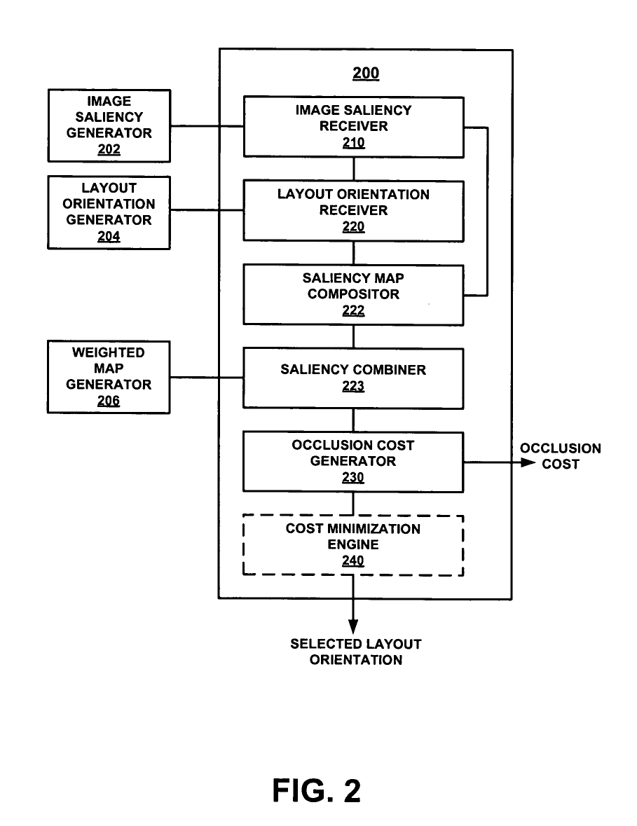

With reference now to FIG. 2, a block diagram is shown of a weighted occlusion costing system 200 which determines a weighted occlusion cost for the layout of a digital image (referred to herein as an “image” or “images”). The following discussion will begin with a description of the structure system 200. This discussion will then be followed with a description of example methods of operation of system 200.

### Structure of an Example Weighted Occlusion Costing System

Still referring to FIG. 2, weighted occlusion costing system 200 is comprised of an image saliency receiver 210, a layout orientation receiver 220, a saliency map compositor 222, a saliency combiner 223, an occlusion cost generator 230, and an optional cost minimization engine 240. Image saliency receiver 210 and layout orientation receiver 220 are coupled to saliency map compositor 222. Saliency map compositor 222 is coupled with saliency combiner 223. Saliency combiner 223 is coupled with occlusion cost generator 230. Occlusion cost generator 230 is optionally coupled to cost minimization engine 240 (when present).

In system 200, image saliency receiver 210 receives saliency data, such as a saliency map, for an image to be displayed in a non-uniform viewing region. In one embodiment, this saliency information is received via a coupling to an image saliency generator 202. Image saliency receiver 210 supplies the image saliency data to saliency map compositor 222 as required.

Layout orientation receiver 220 receives at least one layout orientation for presenting the image in a non-uniform viewing region. In one embodiment, this saliency information is received via a coupling to a layout orientation generator 204, which provides one or more layouts for displaying an image within viewing region. Layout orientation receiver 220 supplies the one or more layout orientations to saliency map compositor 222 as required.

Saliency map compositor 222 utilizes image saliency data for an image and a layout orientation for the image to determine a layout saliency distribution for the layout of the image. Saliency map compositor 222 can create a saliency distribution for a single layout orientation or can create individual layout saliency distributions for a plurality of layout orientations. Saliency map compositor 222 provides one or more layout saliency distributions to saliency combiner 223 as required. Though shown separately for purposes of clarity, it is appreciated that one or more of image saliency receiver 210 and layout orientation receiver 220 may be incorporated into saliency map compositor 222 in some embodiments.

Saliency combiner 223 receives a weighted saliency map of the non-uniform viewing region that image layout orientations are being generated to be displayed within. In some embodiments, the weighted saliency map is received from a stored library of such weighted saliency maps. In some embodiments, the weighted saliency map is received from a saliency map generator 206, which generates weighted saliency maps for non-uniform viewing regions. Such weighted saliency maps may be generated either automatically, from predefined maps, or with some amount of user input to define variant levels of viewable saliency for portions of a non-uniform viewing region.

Saliency combiner 223 utilizes the weighted saliency map of the non-uniform viewing region and the layout saliency distribution to determine a weighted saliency distribution of the layout orientation of the image within the non-uniform viewing region. As will be seen, in one embodiment, saliency combiner 223 multiplies the saliency values for like pixel location in the weighted saliency map and the layout saliency distribution to determine a resultant weighted saliency distribution of the layout orientation. Saliency combiner 223 supplies weighted saliency maps for individual layout orientations to occlusion cost generator 230 as required.

Occlusion cost generator 230 determines a weighted occlusion cost for the layout orientation from said weighted saliency distribution. The weighted occlusion cost provides a numerical representation of the amount of saliency from the image which is viewable within the non-uniform viewing region. In some embodiments, the weighted occlusion cost for a layout or for each of a plurality of layouts is output by occlusion cost generator 230 for further image analysis use. In some embodiments, where optional cost minimization engine 240 is utilized, occlusion cost generator 230 supplies one or more weighted occlusion costs to cost minimization engine 240.

Cost minimization engine 240 determines a lowest weighted occlusion cost layout of the image within the non-uniform viewing region by comparing weighted occlusion costs for a plurality of layout orientations. The image layout orientation with the lowest weighted occlusion cost of those compared is then output as a selected layout orientation.

### Example Methods of Operation

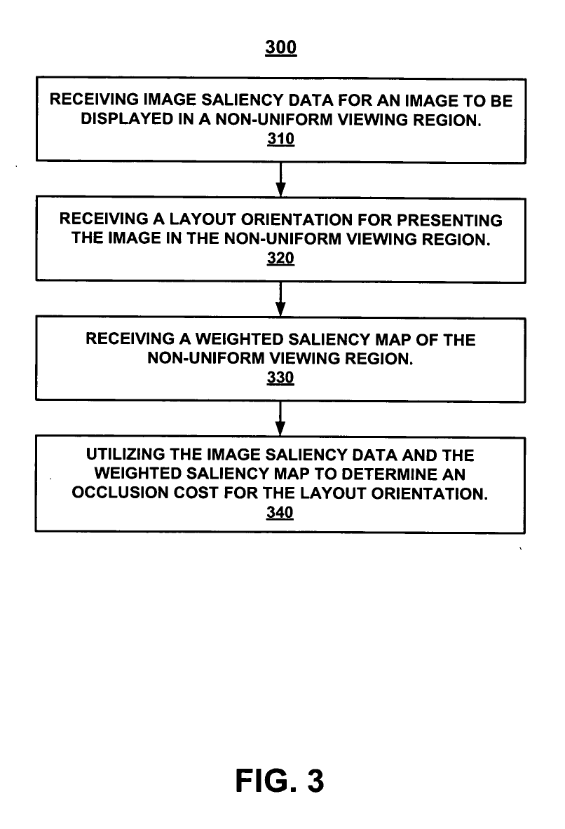

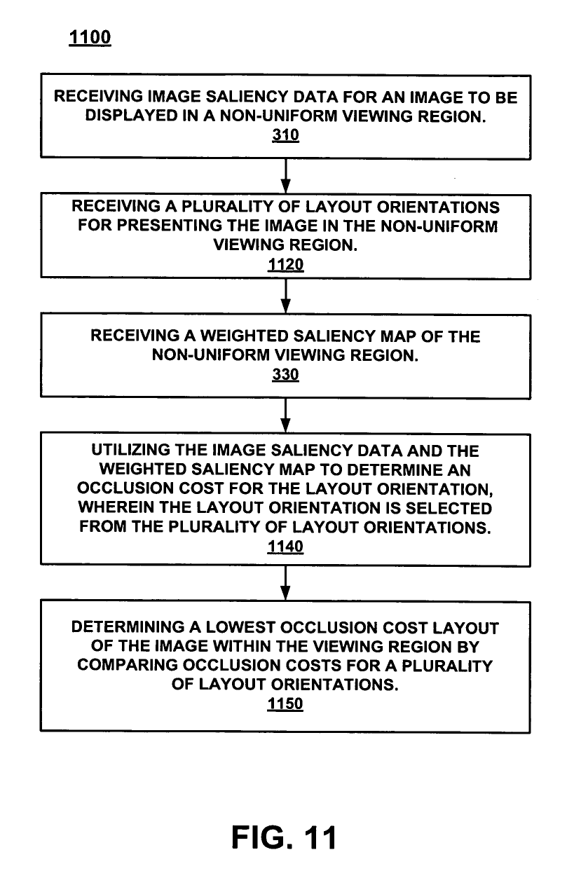

The following discussion sets forth in detail the operation of present technology through description of example embodiments. With reference to FIGS. 3 and 11, flow diagrams 300 and 1100 each illustrate example steps used by various embodiments of the present technology. Flow diagrams 300 and 1100 include processes that, in various embodiments, are carried out by a processor under the control of computer-readable and computer-executable instructions. The computer-readable and computer-executable instructions reside, for example, in data storage features such as computer usable volatile memory 108, computer usable non-volatile memory 110, and/or data storage unit 112 of FIG. 1. The computer-readable and computer-executable instructions are used to control or operate in conjunction with, for example, processor 106A and/or processors 106A, 106B, and 106C of FIG. 1. Although specific steps are disclosed in flow diagrams 300 and 1100, such steps are examples. That is, embodiments are well suited to performing various other steps or variations of the steps recited in flow diagrams 300 and 1100. It is appreciated that the steps in flow diagrams 300 and 1100 may be performed in an order different than presented, and that not all of the steps in flow diagrams 300 and 1100 may be performed.

### Example Method for Determining a Weighted Occlusion Cost for Presenting an Image within a Non-Uniform Viewing Region

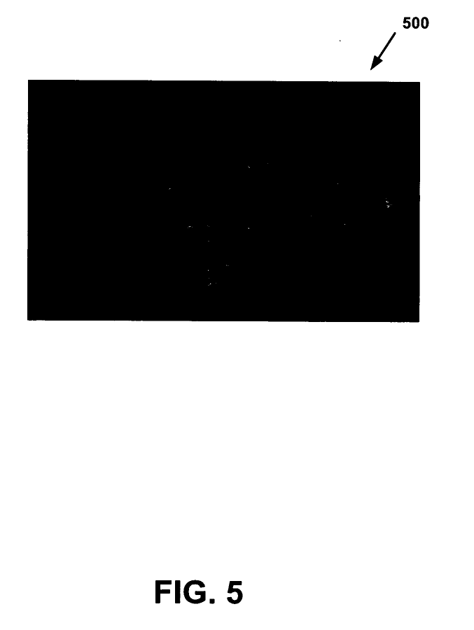

FIG. 3 is a flow diagram 300 of a method, for determining a weighted occlusion cost for presenting an image within a non-uniform viewing region, in accordance with an embodiment of the present technology. Description of flow diagram 300 is facilitated by reference to elements shown in FIGS. 5-10 and FIG. 12.

At 310 of flow diagram 300, in one embodiment, the method receives image saliency data of an image to be displayed in a non-uniform viewing region. Image saliency receiver 210 is configured to receive image saliency data for an image to be displayed in a non-uniform viewing region. As shown in FIG. 2, such image saliency data may be received via a coupling to a source such as image saliency generator 202. Such saliency data is well known in the art and techniques for recognizing objects and determining salient (or interesting) portions of images are known, and described in works such as, A Model of Saliency-Based Visual Attention for Rapid Scene Analysis, Laurent Itti, Christof Koch, and Ernst Niebur, IEEE Transactions on Pattern Analysis and Machine Intelligence, November 1998; and Robust Real-Time Object Detection, Paul Viola and Michael Jones, Second International Workshop on Statistical and Computational Theories of Vision—Modeling, Learning, Computing, and Sampling, Jul. 13, 3001.

Image comprises information such as saliency maps, facial recognition information, and other image analysis information. Image saliency generator 202 generates saliency data based on well-known and established image processing techniques, such as techniques for determining saliency and recognizing objects such as faces. In some embodiments, image saliency generator 202 also generates the image saliency information based on user-specified parameters received from optional user input. Image saliency generator 202 then passes saliency data for each image to image saliency receiver 210 in a form such as a ranking or mapping of salient areas of an image (or images if multiple images are being concurrently presented).

For instance, in some embodiments, the image saliency data received by image saliency receiver 210 is represented as a grayscale map of the image, where the grayscale value of each pixel is the saliency score for that pixel. In other embodiments, each image has saliency data passed in the form of a map, which may contain scores indicating the relative saliency of each section of the map. If more than one image is being processed for layout, saliency data for each of the multiple images is generated and passed to image saliency receiver 210 as described.

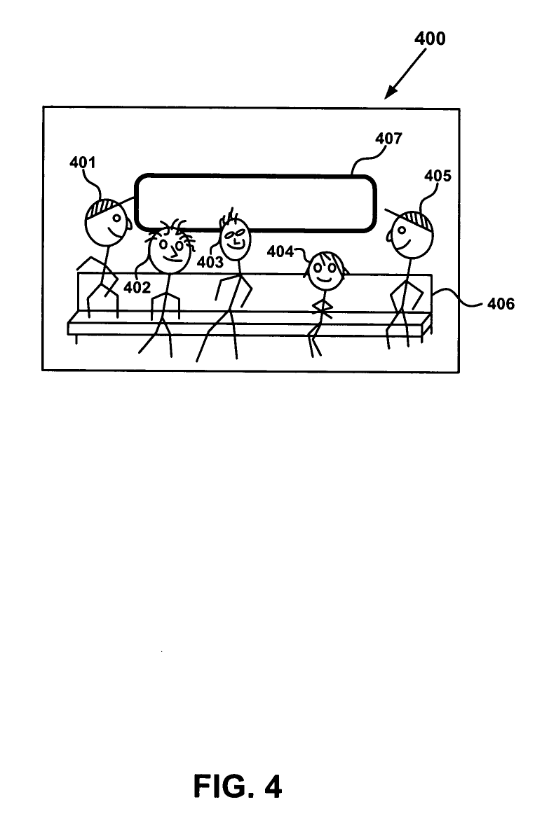

FIG. 4 shows one example of a digital image 400, while FIG. 5 shows an example of a saliency map 500 of image 400 which is received, in one embodiment, by image saliency receiver 210. Saliency map 500 is an example of a grayscale saliency map which represents higher saliency portions of image 400, such as persons 401, 402, 403, 404, and 405, bench 406, and window 407 as lighter shades of grey, with the highest saliency regions being represented as white. Saliency map 500 represents lower saliency portions of image 400 as darker shades of gray, with the lowest saliency regions being represented as black. Image saliency receiver 210 is coupled to saliency map compositor 222, and provides received image saliency data, such as saliency map 500, to saliency map compositor 222 as required.

At 320 of flow diagram 300, in one embodiment, the method receives a layout orientation for the image in the non-uniform viewing region. Layout orientation receiver 220 receives layout orientations for displaying an image, such as image 400, in a non-uniform viewing region. The layout orientations are received via a coupling, for example, to layout orientation generator 204. A plurality of such layout orientations may be received for any particular image. The plurality of layout orientations may be comprised of a variety of x-y orientations of the image relative to the non-uniform viewing region and/or scalings (up or down) of the area of the image relative to the non-uniform viewing region. Thus, layout orientations received by layout orientation receiver 220 contain information such as the size of the image or images being displayed, the location of the image or images within the non-uniform viewing region, and the relative priority of any overlapped images (which image is on top).

It is appreciated that layout orientation receiver 220 can also receive layout orientations in which one or more images have their respective image areas varied, or in which the viewing region area of the non-uniform viewing region is varied. Layout orientation generator 204 generates image layouts utilizing well-known and established techniques for scaling, arranging, and/or overlapping an image or images within a non-uniform viewing region. The layout orientation information is generated based on these techniques, pre-defined layout constraints, and in some embodiments, user-specified constraints supplied by an optional user input.

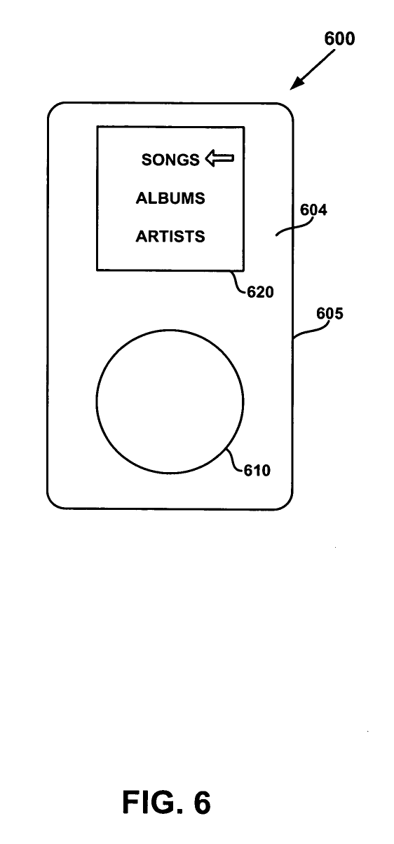

FIG. 6 shows a portable audio player 600, which will be utilized to describe an example embodiment of the present technology. Portable audio player 600 has a body surface 605, a control 610, and a display 620. Body surface 605 is comprised of a front 604, side edges, and a back. Portable audio player 600 represents a non-uniform viewing region for displaying an image on. The non-uniform nature of a viewing region may be due to its shape, the variability of viewable saliency on its surface, or both. In FIG. 6, non-uniformity is due in part to the shape of portable audio player 600 and in part to how a user views portable audio player during its typical operation. For example, control 610 and display 620 are required to be accessible, and are thus not desirable areas to display a portion of an image. Similarly, when held in a user's hand during normal use, only front 604 of portable audio player 600 is highly visible to the user, while the side edges and back have lower visibility or no visibility to the user.

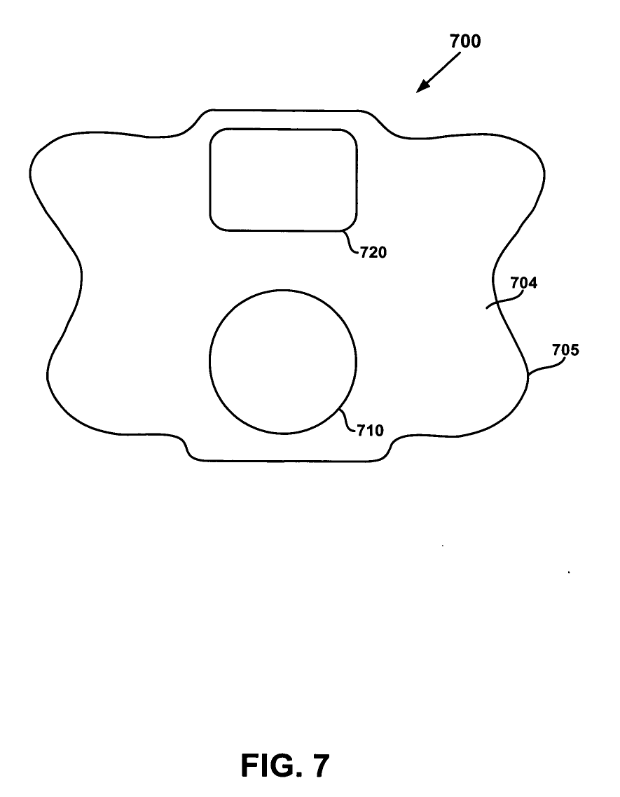

FIG. 7 is an example non-uniform viewing region in the form of a printable decal template 700 for portable audio player 600 shown in FIG. 6. Printable decal template, when printed, has a surface 704, which is defined by edge 705. Surface 704 is configured for wrapping around the body 605 of portable audio player 600. Surface 704 has a first cutout 710 which enables access to control 610 through a printable decal applied to portable audio player 600. Surface 704 has a second cutout 720 which enables viewing display 620 through a printable decal applied to portable audio player 600. In a digital form, printable decal template 700 is an example of a non-uniform viewing region for which layout orientation receiver 220 can receive layout orientations. System 200 can then generate a weighted occlusion cost for such a received layout orientation.

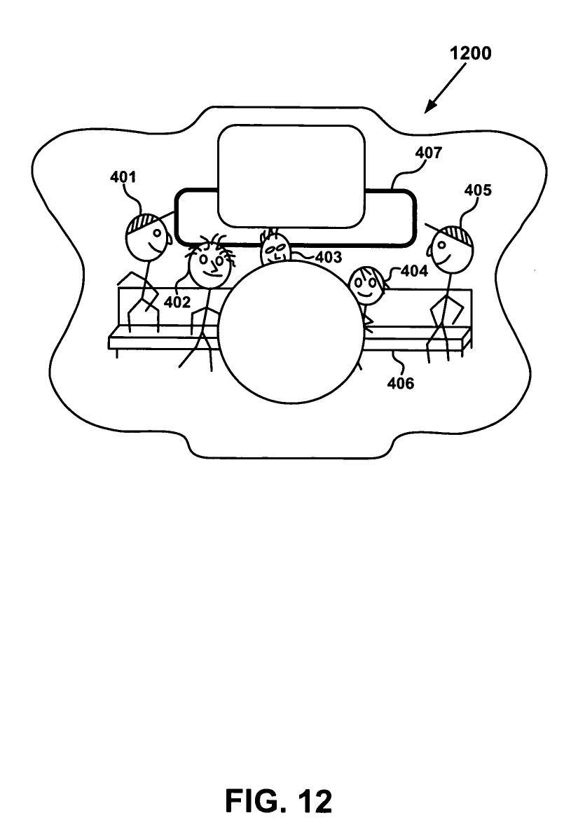

FIG. 12 shows one example of a layout orientation 1200 of image 400 within the non-uniform viewing region of printable decal template 700. Layout orientation receiver 220 is coupled to saliency map compositor 222, and provides received layout orientations, such as layout orientation 1200, to saliency map compositor 222 as required.

At 330 of flow diagram 300, in one embodiment, the method receives a weighted saliency map of the non-uniform viewing region. In the weighted saliency map, a saliency value assigned to an area of the image, such as a pixel, is weighted in proportion to an importance of the visibility of that particular area. In one embodiment, this comprises receiving the weighted saliency map in the form of a grayscale map of the non-uniform viewing region, where areas of high viewable saliency are represented as lighter shades and areas of low viewable salience are represented as darker shades. As shown in FIG. 2, saliency combiner 223 receives the weighted saliency map of the non-uniform viewing region.

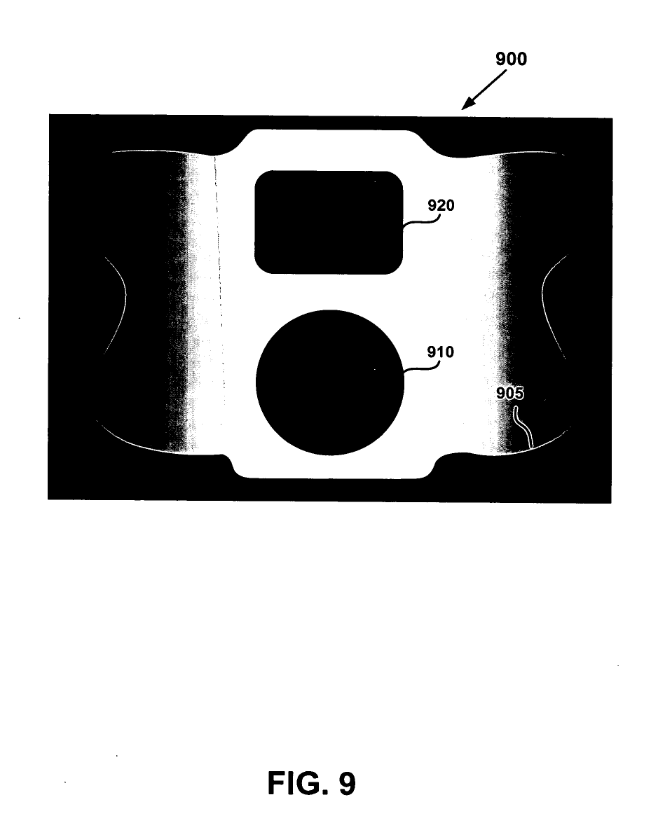

FIG. 9 shows an example weighted saliency map 900 of the non-uniform viewing region represented by printable decal template 700, according to an embodiment. Weighted saliency map 900 is shown in a rectangular format, displaying the weighted viewable saliencies as they would relate to a version of printable decal template 700 that is printed on a rectangular sheet of material. Weighted saliency map 900 shows areas that will not be included in the printable template as black because they have no viewable salience. These areas comprise a circumferential area 905 falling outside the border of printable decal template 700, and areas 910 and 920 which fall inside of cutouts 710 and 720 of printable decal template 700. In some embodiments, areas such as 905, 910, and 920 are not included in weighted saliency map 900. Similarly, darker shades of gray are used on the left and right edges to of weighted saliency map 900 to represent the lower viewable saliency attributed to the side edges and back surface of portable audio player 600. Moving inwardly from the left and right edges toward the center of weighted saliency map 900, the shades of gray become lighter and eventually white. The light gray and white colors of the shades near the center of weighted saliency map 900 represent the increased viewable salience of front 604 of portable audio player 600.

At 340 of flow diagram 300, in one embodiment, the method utilizes the image saliency data and the weighted saliency map to determine a weighted occlusion cost for the received layout orientation. It is appreciated that in embodiments where a plurality of layout orientations for presenting the image in the non-uniform viewing region are received, this can comprise utilizing the image saliency data and the weighted saliency map to determine a weighted occlusion cost for a plurality of the received layout orientations.

In one embodiment, determining a weighed occlusion cost for the received layout orientation first comprises utilizing the received image saliency data for an image and a layout orientation for the image to determine a layout saliency distribution for the layout orientation. Saliency map compositor 222 utilizes the received image saliency data for an image and the layout orientation for the image to determine a layout saliency distribution for a particular layout orientation as displayed in a non-uniform viewing region.

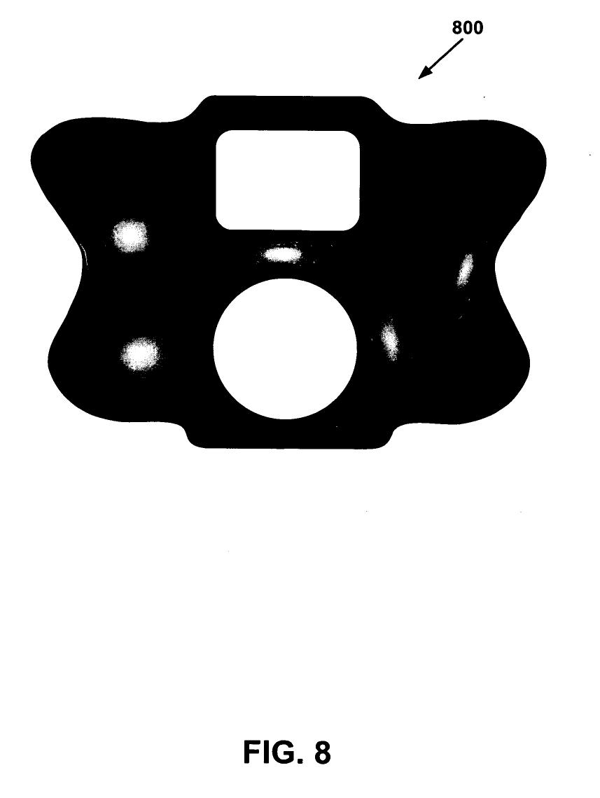

FIG. 8 shows an example layout saliency distribution map 800 for a layout of the digital image 400 within the printable decal template 700 of. In layout saliency distribution map 800, as in image saliency map 500, high saliency portions of image 400, such as persons 401, 402, 403, 404, and 405, as white or as a lighter shade of grey. Likewise, as in saliency map 500, layout saliency distribution map 800 represents lower saliency portions of image 400 as darker shades of gray, with the lowest saliency regions being represented as black.

Saliency map compositor 222 truncates, crops, or otherwise eliminates portions of an image saliency map, such as image saliency map which fall outside of the exterior edge of a non-uniform viewing region, and likewise eliminates portions of a saliency map which lie within a cutout of the non-uniform viewing region. This elimination is a part of the compositing process performed by saliency map compositor 222 to combine the saliency map of a received layout orientation with the non-uniform viewing region within which the layout orientation is being presented. For example, as shown by layout saliency distribution 800 in FIG. 8, saliency map compositor 222 has eliminated the portions of saliency map 500 which fall outside of edge 705 of printable decal template 700 and which lie within cutout regions 710 and 720.

In one embodiment, determining a weighted occlusion cost for the received layout orientation also comprises utilizing the weighted saliency map of the non-uniform viewing region and the layout saliency distribution to determine a weighed saliency distribution of the layout orientation of the image within the non-uniform viewing region; and determining the weighted occlusion cost for the layout orientation from the weighted saliency distribution. Saliency combiner 223 combines the weighted saliency map of the non-uniform viewing region with the layout saliency distribution of a particular layout orientation. As previously indicated, one means for performing this combining is to multiply saliency values of like-located pixels in the two saliency maps with another. The weighed visible saliency equation shown in Table 1 provides one example of how saliency combiner 223 combines a weighed saliency map of a non-uniform viewing region with a layout saliency distribution of a layout orientation.

TABLE 1
Example Equation for Calculating Weighed Visible Saliency
The weighted visible saliency, Vi, of image “i”, is given by:
${V}_{i} = \frac{{\sum }_{x , y} S ( x , y ) * V ( x , y )}{{\sum }_{x , y} S ( x , y )} ,$
where S(x,y) is the grayscale saliency map, and V(x,y) is the grayscale
saliency (visibility) of the viewing region.

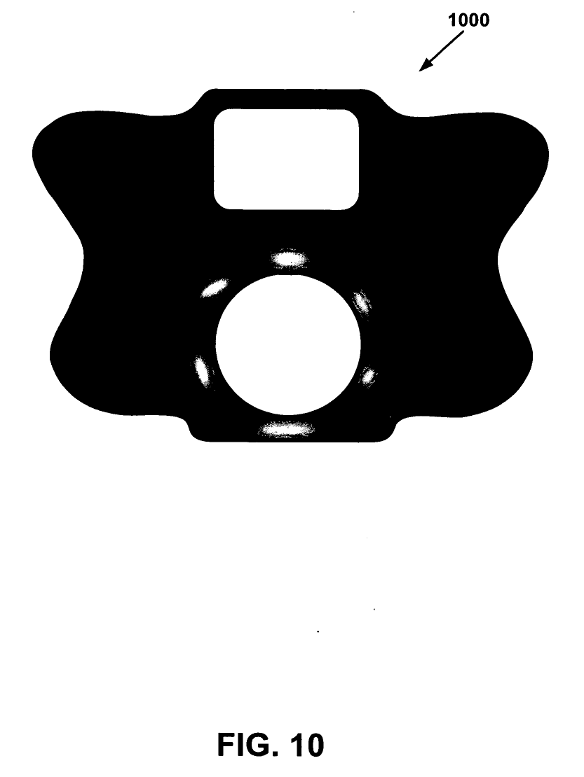

FIG. 10 is an example mapping of the weighted saliency distribution 1000 for one layout of the digital image of FIG. 4 displayed within the printable decal template of FIG. 7. In one embodiment, saliency combiner 223 produces weighted saliency distribution 1000 by combining (such as through multiplication) the like-located saliencies for the in-common areas shown in weighted saliency map 900 and layout saliency distribution 800. Weighted saliency distribution 1000 is lighter near the center and darker near the left and right edges. This grayscale coloring of weighted saliency distribution 1000 emphasizes the saliency of the layout orientation which will be highly viewable on front 604 of portable audio player 600 when the printable decal template is applied. This grayscale coloring of weighted saliency distribution 1000 also de-emphasizes the less viewable salience of the layout orientation which will cover the side edges and back of portable audio player 600 when the printable decal is applied.

Occlusion cost generator 230 receives weighted saliency distribution 1000 from saliency combiner 223 and then calculates the weighted occlusion cost for presenting the layout orientation in the non-uniform viewing region from weighted saliency distributions 1000. The weighted occlusion cost is “weighted” because it is calculated from a saliency distribution of the image that is weighted to account for viewable saliency variation within the non-uniform viewing region. In some embodiments, this comprises calculating the weighted occlusion cost for presenting the image within a projected, displayed, or print media viewing region. One example of a print media viewing region is a templated print media such as printable decal template 700. In some embodiments, where a plurality of layout orientations are received for evaluation by system 200, occlusion cost generator 230 calculates the weighted occlusion cost for a plurality of weighted saliency distributions which are generated from the plurality of received layout orientations.

Occlusion cost generator 230 determines a quantitative occlusion cost associated with the relative position(s) of, and any potential overlapping between, the one or more images to be displayed in a non-uniform viewing region. The cost equation shown in Table 2 provides one example of how occlusion cost generator 230 determines a weighted occlusion cost for an image or images in a layout.

The equation in Table 2 calculates the level of saliency for occluded regions in an image (or images) from a weighted viewable salience (Vi). The result is a weighted occlusion cost for having a region of an image covered or occluded in a layout orientation. The equation in Table 2 can be used to determine the weighted occlusion cost for a layout orientation of a single image to be displayed alone in a non-uniform viewing region. It can also be modified to calculate the weighted occlusion cost for a layout of multiple images being displayed concurrently in a non-uniform viewing region. The cost value (C) is generated in a range from zero to one and can be thought of as a percentage. A cost closer to one equals nearly total occlusion. A cost closer to zero indicates very little occlusion.

TABLE 2
Example Equation for Calculating Occlusion Cost of a Layout
The overall occlusion cost is given by:
$C = {\sum }_{i} ( 1 - {V}_{i} )$

It is appreciated that additional user-specified values can be added directly into occlusion cost generator 230 as non-linearities to be incorporated in the weighted occlusion cost determination, or can be added directly to the saliency data generated by image saliency generator 202. For instance, in one embodiment, if it is important that a certain face (or a specific image region) not be occluded, the face can be marked with high saliency in the image saliency data/map by setting a user-defined parameter. This ensures that in most cases if a face marked in such a manner is occluded, a high weighted occlusion cost (of one or close to one) will result from the weighted occlusion cost determination generated by occlusion cost generator 230. The weighted occlusion costs generated by occlusion cost generator 230 can be output in a variety of forms such as a list, a rank ordering, or a data stream.

### Example Method for Determining a Layout Orientation for Presenting an Image within a Non-Uniform Viewing Region

FIG. 11 is a flow diagram 1100 of a method, for determining a layout orientation for presenting an image within a non-uniform viewing region, in accordance with an embodiment of the present technology. Description of flow diagram 1100 is facilitated by reference to elements shown in FIGS. 5-10 and FIGS. 12-13, and flow diagram 300 of FIG. 3.

At 310 of flow diagram 1100, in one embodiment, the method receives image saliency data of an image to be displayed in a non-uniform viewing region. Reference is made to the description of step 310 of flow diagram 300, which is the same as step 310 of flow diagram 1100. In the interests of brevity and clarity step 310 will not be described again herein.

At 1120 of flow diagram 1100, in one embodiment, the method receives a plurality of layout orientations for presenting the image in the non-uniform viewing region. Reference is made to the description of step 320 of flow diagram 300. Step 1120 is consistent with the description of step 320 except that a plurality of layout orientations is received. In the interests of brevity and clarity additional description of step 320 will not be repeated again herein.

At 330 of flow diagram 1100, in one embodiment, the method receives a weighted saliency map of the non-uniform viewing region. Reference is made to the description of step 330 of flow diagram 300, which is the same as step 330 of flow diagram 1100. In the interests of brevity and clarity step 330 will not be described again herein.

At 330 of flow diagram 1100, in one embodiment, the method utilizes the image saliency data and the weighed saliency map to determine a weighted occlusion cost for a layout orientation, wherein the layout orientation is selected from one of the plurality of layout orientations received in step 1120. Reference is made to the description of step 340 of flow diagram 300, which is the same as step 1140 of flow diagram 1100 except that the layout orientation to be evaluated is one of a plurality of received layout orientations. In the interests of brevity and clarity additional description of step 340 will not be repeated again herein.

At 1150 of flow diagram 1100, in one embodiment, the method determines a lowest weighted occlusion cost layout of the image within the non-uniform viewing region by comparing weighted occlusion costs that have been generated for a plurality of the received layout orientations. Cost minimization engine 240 determines of the lowest weighted occlusion cost.

As shown in FIG. 2, the weighted occlusion costs that are output from occlusion cost generator 230 may be used as an input to cost minimization engine 240. Cost minimization engine 240 compares the costs for a variety of layouts and chooses the lowest cost layout from the layout orientations for an image (or plurality of concurrently displayed images) for which occlusion cost generator 230 calculates a weighted occlusion cost.

In some embodiments, cost minimization engine 240 passively receives weighted occlusion cost data for various layouts of an image or multiple images within a non-uniform viewing region. Cost minimization engine 240 then chooses the lowest weighted occlusion cost layout from among the received layout orientations. This lowest cost layout is then output from cost minimization engine 240 for display, printing, or further processing. If all evaluated weighted occlusion costs are unacceptably high, (for example in comparison to a predefined or user defined threshold) cost minimization engine 240 indicates this as an output. In such embodiments, layout orientation generator 204 iteratively generates a preset number of layout orientations, generates layout orientations for a preset amount of time, generates layout orientations until a stop command is received, or attempts to generate all possible layout orientations for displaying an image within the non-uniform viewing region.

In some embodiments, cost minimization engine 240 uses well known mathematical modeling and projection techniques, such as steepest decent, to reduce calculations by homing in on the layout orientation that will have the lowest weighted occlusion cost. In some such embodiments, cost minimization engine 240 communicates with occlusion cost generator 230 to steer it toward calculating weighted occlusion costs for certain image layout orientations, thus saving time and reducing calculations. In some embodiments, the communication also encompasses communication with layout orientation generator 204 to actively steer layout orientation generator 204 towards generating the layout orientation with the lowest weighted occlusion cost. Such active steering reduces calculations and speeds layout orientation generation and weighted occlusion cost generation by lowering the number of images generated and evaluated.

FIG. 12 an example of a layout orientation 1200 of image 400 within printable decal template 700, according to one embodiment. In one embodiment, after evaluating the weighted occlusion costs for a plurality of such layouts, cost minimization engine 240 scores layout 1200 as the layout orientation with the lowest weighted occlusion cost and outputs it as the selected layout orientation. As can be seen from FIG. 1200 a large amount of the salient features of image 400, such large portions of persons 402, 403, and 404, bench 406, and window 407 are advantageously arranged to fall on the portion of printable decal template 700 which will have high viewable saliency on the front 604 of portable audio player 600, when applied as a printable decal. Portions of persons 401 and 405 are located on areas of printable decal template 700 which will have a lower viewable saliency when applied to portable audio player 600.

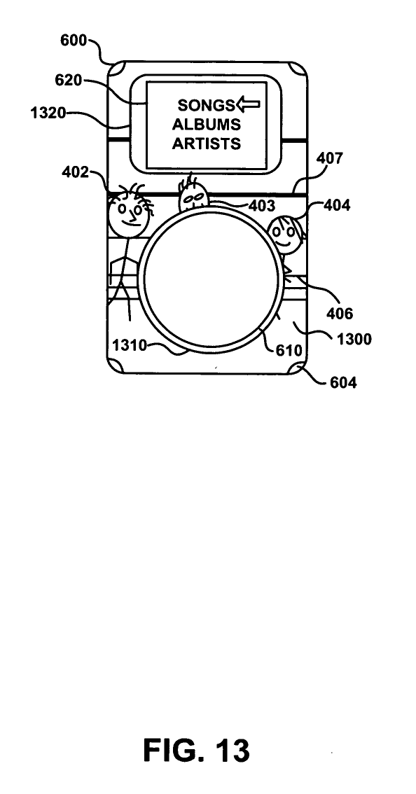

FIG. 13 is an example of a printable decal 1300 applied to portable audio player 600, according to one embodiment. Printable decal 1300 is generated from layout orientation 1200. Cutout 1310 facilitates access to control 610. Likewise, cutout 620 facilitates access to display 620. Additionally, large portions of persons 402, 403, and 404 are visible on the front 604 of portable audio player 600, which is where the highest viewable salience of the non-uniform viewing region of portable audio player 600 is concentrated.

Though a printable decal template and a portable audio player have served as examples of non-uniform viewing regions, it is not meant to limit the scope of non-uniform viewing regions to such embodiments. On the contrary, it is appreciated that a large variety of other non-uniform viewing regions exist and can be used for displaying images utilizing the teachings of the present technology as illustrate herein.

Although the subject matter of the present technology has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for determining a weighted occlusion cost for presenting an image within a non-uniform viewing region, said method comprising:
receiving image saliency data for an image to be displayed in a non-uniform viewing region;
receiving a layout orientation for presenting said image in said non-uniform viewing region;
receiving a weighted saliency map of said non-uniform viewing region; and
utilizing said image saliency data and said weighted saliency map to determine a weighted occlusion cost for said layout orientation.

2. The method as recited in claim 1, wherein said receiving image saliency data for an image to be displayed in a non-uniform viewing region comprises:
receiving said image saliency data in the form of a grayscale map of said image.

3. The method as recited in claim 1, wherein said receiving a weighted saliency map of said non-uniform viewing region comprises:
receiving a weighted grayscale map of said non-uniform viewing region.

4. The method as recited in claim 1, wherein said receiving a weighted saliency map of said non-uniform viewing region comprises:
receiving said weighted saliency map of said non-uniform viewing region, wherein a saliency value assigned to an area within said non-uniform viewing region is weighted in proportion to an importance of visibility of said area.

5. The method as recited in claim 1, wherein said utilizing said image saliency data and said weighted saliency map to determine a weighted occlusion cost for said layout orientation comprises:
utilizing said image saliency data and said layout orientation to determine a layout saliency distribution.

6. The method as recited in claim 5, wherein said utilizing said image saliency data and said weighted saliency map to determine a weighted occlusion cost for said layout orientation further comprises:
utilizing said weighted saliency map of said non-uniform viewing region and said layout saliency distribution to determine a weighted saliency distribution of said layout orientation of said image within said non-uniform viewing region; and
determining said weighted occlusion cost for said layout orientation from said weighted saliency distribution.

7. The method as recited in claim 1, wherein said utilizing said image saliency data and said weighted saliency map to determine a weighted occlusion cost for said layout orientation comprises:
determining said weighted occlusion cost for presenting said image within a templated print media.

8. The method as recited in claim 1, further comprising:
receiving a plurality of layout orientations for presenting said image in said non-uniform viewing region.

9. The method as recited in claim 8, wherein said utilizing said image saliency data and said weighted saliency map to determine a weighted occlusion cost for said layout orientation comprises:
utilizing said image saliency data and said weighted saliency map to determine a weighted occlusion cost for a plurality of said layout orientations.

10. A method for determining a layout orientation for presenting an image within a non-uniform viewing region, said method comprising:
receiving image saliency data for an image to be displayed in a non-uniform viewing region;
receiving a plurality of layout orientations for presenting said image in said non-uniform viewing region;
receiving a weighted saliency map of said non-uniform viewing region;
utilizing said image saliency data and said weighted saliency map to determine a weighted occlusion cost for a layout orientation, wherein said layout orientation is selected from said plurality of layout orientations; and
determining a lowest weighted occlusion cost layout of said image within said viewing region by comparing weighted occlusion costs for a plurality of said layout orientations.

11. The method as recited in claim 10, wherein said receiving image saliency data for an image to be displayed in a non-uniform viewing region comprises:
receiving said image saliency data in the form of a grayscale map of said image.

12. The method as recited in claim 1, wherein said receiving a weighted saliency map of said non-uniform viewing region comprises:
receiving a weighted grayscale map of said non-uniform viewing region.

13. The method as recited in claim 10, wherein said receiving a weighted saliency map of said non-uniform viewing region comprises:
receiving said weighted saliency map of said non-uniform viewing region, wherein saliency assigned to an area within said non-uniform viewing region is weighted in proportion to an importance of visibility of said area.

14. The method as recited in claim 10, wherein said utilizing said image saliency data and said weighted saliency map to determine a weighted occlusion cost for a layout orientation comprises:
utilizing said image saliency data and said layout orientation to determine said layout saliency distribution.

15. The method as recited in claim 14, wherein said utilizing said image saliency data and said weighted saliency map to determine a weighted occlusion cost for a layout orientation further comprises:
utilizing said weighted saliency map of said non-uniform viewing region and said layout saliency distribution to determine a weighted saliency distribution of said layout orientation of said image within said non-uniform viewing region; and
determining said weighted occlusion cost for said layout orientation from said weighted saliency distribution.

16. The method as recited in claim 10, wherein said utilizing said image saliency data and said weighted saliency map to determine a weighted occlusion cost for a layout orientation comprises:
determining said weighted occlusion cost for presenting said image within a templated print media.

17. A weighted occlusion costing system, said system comprising:
a saliency map compositor configured for utilizing image saliency data for an image and a layout orientation for said image to determine a layout saliency distribution;
an saliency combiner coupled to said saliency map compositor, said saliency combiner configured for utilizing a weighted saliency map of said non-uniform viewing region and said layout saliency distribution to determine a weighted saliency distribution of said layout orientation of said image within said non-uniform viewing region; and
an occlusion cost generator coupled to said saliency multiplier, said occlusion cost generator configured for determining a weighted occlusion cost for said layout orientation from said weighted saliency distribution.

18. The system of claim 17, further comprising:
a cost minimization engine coupled to said occlusion cost generator, said cost minimization engine configured for determining a lowest weighted occlusion cost layout of said image within said non-uniform viewing region by comparing weighted occlusion costs for a plurality of said layout orientations.

19. The system of claim 17, further comprising:
an image saliency receiver coupled with said saliency map compositor, said image saliency receiver configured for receiving saliency data for said image.

20. The system of claim 17, further comprising:
a layout orientation receiver coupled with said saliency map compositor, said layout orientation receiver configured for receiving at least one layout orientation for presenting said image in said non-uniform viewing region.
